(19) United States
(12) Patent Application Publication
(10) Pub. No.: US 2005/0088363 A1
(43) Pub. Date: Apr. 28, 2005

(54) Multi-frequency band antenna and methods of tuning and manufacture

(76) Inventors: Ovadia Grossman, Tel Aviv (IL); Moshe Ben-Ayun, Shoham (IL); Salem Yaniv, Tel Aviv (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/991,121

(22) Filed: Nov. 17, 2004

(30) Foreign Application Priority Data
Jun. 1, 2002 (GB) GB0212832.0
May 23, 2003 (WO) PCT/EP03/50191

(51) Int. Cl. H01Q 1/36

(52) U.S. Cl. 343/895

(57) ABSTRACT

A multi-frequency band antenna (100) includes a dual-pitch coil (120, 130), and a top insert (140), operably coupled to an antenna base (105). The multi-frequency band antenna (100) is configured to radiate electromagnetic signals at a lower frequency 230) of multi-frequencies using substantially the whole of the dual-pitch coil (120, 130); and at a higher frequency (240) of said multi-frequencies using a length of said antenna base (105, 110) and a portion of said dual-pitch coil (120). A first portion of the dual-pitch coil has a longer pitch than a second portion of the coil and the first portion has a first end attached to the antenna base and a second end attached to the second portion, and the second portion has an effective electrical length substantially equal to a wavelength (λ) of radiation having a frequency corresponding to a frequency in the second band.

### FIELD OF THE INVENTION

This invention relates to a multi-frequency band antenna and methods of tuning of the same. The invention is applicable to, but not limited to, antennae for use in multi-mode wireless communication products.

### BACKGROUND OF THE INVENTION

In the provision of wireless communication, antennae are used to radiate or absorb electromagnetic signals sent between wireless communication units. An antenna is a basic component of any electronic system that requires free space as a propagation medium. An antenna is a device that provides a means for radiating or receiving radio waves. It is a transducer between, say, a guided electromagnetic wave and an electromagnetic wave propagating in free space.

In a communication link, a transmitter circuit of a first communication device may be connected through a coaxial cable, a microstrip transmission line or other such means to an antenna. The signal to be transmitted is radiated in free space where it is ‘picked up’ by an antenna of a second communication unit. In the second communication unit, the received signal is passed through, say, another coaxial cable, a microstrip transmission line or other similar structure to a receiver circuit. A 50 ohm characteristic impedance is usually taken as standard for such links to/from antennae, although domestic cables use, however, a 75 ohm characteristic impedance.

Notwithstanding the considerable differences in physical realisation of antennae for different frequencies and purposes, there are certain basic properties that define the function and operation of an antenna. The properties most often of interest in the design of an antenna are: radiation pattern, antenna gain, polarisation and impedance. For a linear, passive antenna, these properties are identical for the transmitting and receiving operations of the antenna, by virtue of the reciprocity theorem, as known to those skilled in the art.

The radiation pattern of an antenna determines the spatial distribution of the radiated energy. For example, a vertical wire antenna gives uniform coverage in the horizontal (azimuth) plane, with some vertical directionality, and as such is often used for broadcasting purposes.

As an alternative to a radiation pattern providing a uniform coverage, an antenna can have a directional radiation pattern. The directional properties of antennae are frequently expressed in terms of a gain function. The gain of an antenna is defined as the ratio of the maximum radiation intensity from the antenna to the maximum from a reference antenna having the same input power. The reference antenna for this purpose is usually a hypothetical loss-less isotropic radiator and the gain is subsequently expressed in dBi (dB level with reference to an isotropic radiator).

However, realisable antennae are never “ideal” and some loss of signal throughput occurs. In such a case, the fraction of power reflected by a non-ideal antenna is:

$$\begin{matrix}{ρ}_{refl} / {ρ}_{inc} = {\vert Γ \vert}^{2} & ( 2 ) \\ = \frac{{\vert {Z}_{in} - {Z}_{o} \vert}^{2}}{\vert {Z}_{in} + {Z}_{o} \vert} & ( 3 )\end{matrix}$$

Where Zᵢₙ is the antenna input impedance, Zₒ the line impedance and Γ is the voltage reflection coefficient (otherwise known as return loss). Zᵢₙ is a function of frequency, and its variation with frequency, or that of |Γ|, is usually the parameter, together with the voltage standing wave ratio (VSWR) of the antenna, that is determined to assess the efficiency of the antenna.

In the field of wireless communication, there has been a recent trend to provide wireless communication units, especially for use in mobile stations, that are operable in more than one frequency band, for example the Motorola™ Timeport™ cellular phone. One impact on the design of such communication units is that an antenna design needs to be suitably operable in a plurality of discrete frequency bands. Ideally, an antenna designer needs to design an antenna structure with two or more independent radiators, in order to achieve the radiation performance required for a communication unit to operate in each band. However each such antenna consumes space and contributes significantly to the cost of manufacture of the unit. It is well recognised by skilled artisans in the field of antenna design that it is very difficult to design a single antenna structure that is able to provide acceptable radiation performance at two or more discrete frequency bands. Furthermore, each frequency band typically requires its own decoupling/orthogonal element to achieve optimal radiation. Known antenna structures are based on an orthogonal design (from the radiation point of view).

However, an orthogonal structure design, such as a standard whip antenna has the disadvantage that the length of the whip, in order to radiate signals at, say, an operational frequency of approximately 400 MHz in accordance with TETRA standards, must be greater than 18 cm in length, and at 800 MHz greater than 8 cm. Such antenna sizes are unsightly to customers. Furthermore, with antennae of this length, an antenna designer has no control over the radiation pattern at the higher frequency ranges.

The inventors of the present invention have recognised a need for an improved antenna which provides multi-band antenna operation, for example in at least a TETRA band in the range of about 380-450 MHz, in a lower frequency GSM band in the range of about 850-960 MHz, and preferably in a higher frequency GSM band in the range of about 1700-1900 MHz. A wireless communication unit, for example a portable radio or cellular phone that requires a compact, smaller size antenna, would benefit from such a multi-frequency band antenna design.

This type of multi-frequency band antenna does not exist as a commercial product, specifically because the main development effort in the market is for antennae operating at frequencies above about 800 MHz. It is also well appreciated that maintaining a small antenna size is a critical factor in the sales of wireless communication units, primarily for customer convenience and better aesthetic appearance. The inventors of the present invention are not aware of any current antenna design that could provide a dual-band or a triple-band performance whilst having a suitably short overall antenna length, which is suitable to radiate at TETRA frequencies of about 400 MHz.

### SUMMARY OF THE INVENTION

In accordance with a first aspect of the preferred embodiment of the present invention, a multi-frequency band antenna for wireless communications comprises a coil having a plurality of portions each having a different pitch including a first portion having a first pitch and a second portion having a second pitch, and an antenna base operably coupled to the coil for operable coupling to a multi-mode wireless transmitter, wherein the antenna is configured to radiate in use electromagnetic signals: in a first frequency band of said multi-frequency bands using the first and second portions of the coil; and in a second frequency band of said multi-frequency bands which is higher in frequency than the first frequency band using a length of said antenna base and substantially the first portion of the coil, wherein the first portion has a longer pitch than the second portion and the first portion has a first end attached to the antenna base and a second end attached to the second portion, and wherein the second portion has an effective electrical length substantially equivalent to a wavelength λ of radiation having a frequency corresponding to a frequency in the second band. The coil of the antenna may be a dual-pitch coil.

In this manner, the respective antenna lengths can be readily adjusted so that the antenna, when coupled to a wireless communication unit, can radiate signals at any of the desired frequencies, without changing either the pitch or the overall length of the coil.

In a preferred embodiment of the invention, the multi-frequency band antenna includes a base elongation mechanism operably coupled to the antenna base, to provide an additional high radiating frequency.

In a preferred embodiment of the invention, the antenna is configured before manufacture, to radiate at a frequency, say, approximately 10% higher than the lower desired frequency, to take into account a corresponding reduction in the target lower frequency due to injection moulding of the antenna.

Preferably, a stub extension is lightly coupled to the coil to effect a change in a frequency ratio between a higher resonant frequency and a lower resonant frequency at which the antenna is to operate.

In an embodiment of the present invention there is provided a method of tuning a multi-frequency band antenna according to the first aspect. The coil is able to slide over the antenna base. The method includes the step of varying a length of a high-pitch coil portion of the coil of the antenna by moving the high-pitch coil portion over the base of the antenna, thereby tuning a higher radiation frequency generated by the multi-pitch coil.

In this manner, and advantageously, accurate antenna radiation across multiple frequency bands can be readily controlled.

In a third aspect of the preferred embodiment of the present invention, a wireless communication unit incorporating the antenna according to the first aspect is provided.

The novel antenna according to the first aspect of the invention is suitable for use in a radio transmitter or receiver or transceiver for mobile communications, e.g. for use in a mobile station or terminal for transmission and/or reception of radio signals carrying information, e.g. one or more of speech, text or data, picture or video information and systems control information. In principle, there is no restriction on the operational frequency of the communications possible using the antenna, but most beneficial use of the antenna is likely to be found in the operational frequency range 30 MHz to 5 GHz at selected opearational frequencies in this range, especially at least frequencies in the bands specified later.

In summary, the antenna in accordance with the present invention has a single radiating element that has a unique radiating configuration beneficially allowing a wireless communication unit to radiate or receive radio signals at two or more, preferably three or more widely separated frequencies.

The maximum length desired for short antennae e.g. for use in modern mobile station transceivers, is 100 mm. Preferably the length of the antenna according to the invention is not greater than, desirably less than, 60 mm, especially less than 50 mm.

One benefit associated with having such a compact antenna, is that it can be encased by a single injection moulding to provide a robust mechanical performance. Furthermore, the antenna electrical performance can be equal to or better than an equivalent full quarter wave antenna at the desired frequencies.

Exemplary embodiments of the present invention will now be described, with reference to the accompanying drawings, in which:

### BRIEF DESCRIPTION OF THE DRAWINGS

FIG. 1 is a simplified perspective side view of an antenna, for coupling to a dual-mode wireless communication unit, in accordance with an embodiment of the present invention;

FIG. 2 is a return loss versus frequency graph of the antenna shown in FIG. 1.

FIG. 3 is a flowchart of a preferred method of antenna tuning in accordance with the preferred embodiment of the present invention; and

FIG. 4 is a graph illustrating elevation-cut radiation patterns for a known standard helical antenna and the antenna of the preferred embodiment of the present invention.

### DETAILED DESCRIPTION OF EMBODIMENTS OF THE Invention

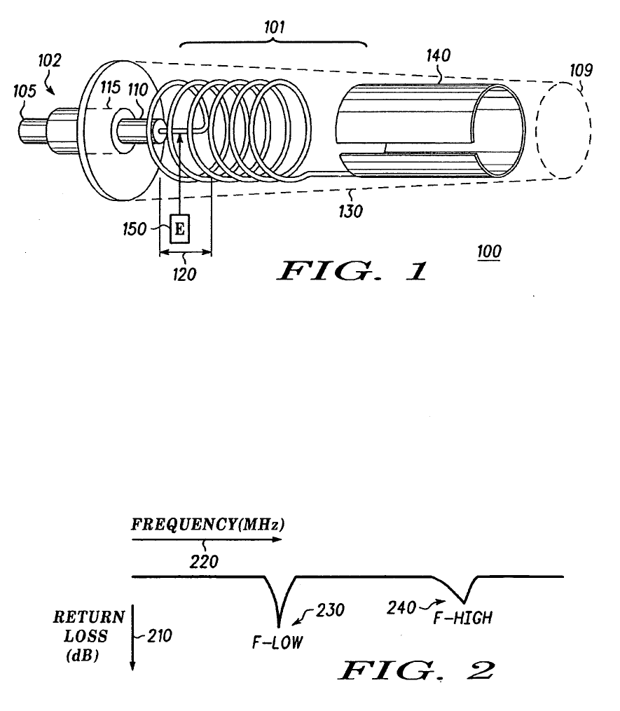

Referring now to FIG. 1, an antenna 100 is shown, for coupling to a multiple-mode wireless communication unit arrangement, in accordance with an embodiment of the present invention. The antenna, indicated in FIG. 1 by reference numeral 100, includes discrete sections A to E forming a unitary antenna construction, including in particular a dual pitch coil 101. Section A of the antenna 100 comprises a conducting cylindrical base 102 which comprises an end portion 105 which in use is attached conductively to a conducting member. The end portion 105 is threaded allowing it to be attached mechanically and electrically to a conducting ground plane (not shown) of the wireless communication unit in a known manner. A cylindrical portion 115 of enlarged diameter is formed between the end portion 105 and a further end portion 110 at the inner end of the base 102. the end portions 110 and 105 have similar diameters. Section B comprises a helical coil portion 120 and Section C which is co-axial with the sections A and B comprises a helical coil portion 130 extending from the end of the coil portion 120 distant from the portion 115. The diameter of the coil portions 120 and 130 is the same and the turns of the portion 120 extend continuously to become the turns of the portion 130 by a change in the coil pitch. Section B coil portion 120 has a coil pitch which is greater than that of Section C coil portion 130. Section D comprises a conducting cylindrical stub 140 extending from the end of the portion 130 distant from the portion 120. Section E comprises a cylindrical conducting finger 150 extending axially from the portion 115 of Section A inside the coil portion 120 of Section B. The diameter of the finger 150 is much smaller than, e.g. about one fifth of, the outside diameter of the turns of the coil portion 120.

The portions 110 and 115 of Section A and Sections B to E are enclosed in a conventional manner in an insulating case 190, e.g. made of a moulded plastics material. The case 190 is conventional and provides mechanical and environmental protection of the antenna 1.

In order to accommodate a first operational frequency for, say, TETRA operation in a selected band in the range 400 MHz to 460 MHz, e.g. centered at 450 MHz, the overall effective length of the antenna 100 (sections A to D) is the determining factor, together with the overall size of a conducting ground plane of a r.f. transmitter (not shown) to which it is connected. The overall effective length of the coil 101 (sections B and C of the antenna 100) for operation in such a TETRA frequency band is selected to be 0.5λ, where λ is the wavelength of the radio signal to be radiated (the frequencies at which the antenna is used are somewhat lower than those obtained initially by design as explained later). This length of the coil 101 determines the operational centre frequency f_{c}, by the relationship c=f_{c}λ where c is the speed of electromagnetic radiation. The centre frequency f_{c} can thus be tuned or trimmed (top trimming), by selecting the effective length of the coil 101 to be 0.5λ, as will be apparent to those skilled in the art, in order to meet the antenna frequency band performance requirements.

The portion 140 of section D contributes in the following manner. Preferably, the portion 140 is only lightly coupled to the coil 101, inasmuch as it touches the last turn of the coil portion 130 but does not extend into the coil 101. The portion acts effectively as a capacitive loading in a known manner at the end of the antenna 101. Selection of the length of the portion 140 allows the resonant frequency of the antenna 100 at the TETRA frequencies to be tuned. At higher frequencies, the coil 101 is by itself capacitive enough to be substantially unaffected by the portion 140. The portion 140 primarily affects the lower resonant frequency. This is especially useful in design and tuning of the antenna 100 as described later.

In order to provide operation at a second operational frequency, e.g. at a first GSM frequency, the radiative combination of Section A and Section B long pitch coil portion 120 become the main components of the antenna. The coil portion 120 is configured to provide good radiation of signals in a GSM band of frequencies, i.e. a band in the range 890 MHz to 960 MHz, by providing a resonance at the selected frequency by use of an antenna effective length of 1.25λ. Section A provides approximately 20 mm of the effective antenna length. Section B high pitch coil portion 120 comprises approximately three turns of the antenna coil 101, with a pitch of about 3.5 mm, a lateral length of about 10 mm and coil curvature length of about 60 mm. In combination, the Section A and Section B of the antenna 100 provide an effective length equivalent to one quarter wavelength (λ/4) to radiate at the required centre GSM frequency. The remaining portion of the coil 101—Section C low pitch coil portion 130—extending beyond Section B, is arranged to be one wavelength (λ) in effective length. In this regard, an 11-turn portion of the coil 101, with a pitch of 1.6 mm, lateral length of 20 mm and coil curvature length of 220 mm is used. Such a coil pitch and coil length are selected to present a high impedance to the λ/4 radiator provided by sections A and B, to allow good radiation at the first selected GSM frequency.

However, as will be apparent to those skilled in the art, the Section C low pitch coil portion 130 of length λ tends to dissipate a significant percentage of the r.f. energy developed. This causes a slight increase in the resonant frequency (by entering the high impedance portion of the Smith chart). Hence, in order to maintain an acceptable antenna gain over the selected GSM band, the antenna 101 is designed with a resonance peak toward the higher end of the GSM range, say at 940-950 MHz, to allow for this increase.

At a third operational frequency, the coil 101 performs as for TETRA operation described earlier but additionally provides a significant resonance at the third harmonic, e.g. at about 1250 MHz, (the second harmonic is usually high impedance and not radiating).

Section C short pitch portion 130 has also been configured to provide radiative resonances at selected additional higher frequencies. The additional resonances are the result of the interaction of the short pitch coil portion 130 with various other parts of the antenna 100. In each case, the main radiative contribution comes from the short pitch coil portion 130. (This has been confirmed using a near field probe in each case to detect radiation emanating from different parts of the antenna).

Thus, a further resonance with a strong contribution from the coil portion 130, occurs at a fourth frequency, e.g. about 1560 MHz, using the dimensions of the coil 101 specified earlier. This resonance can be used for example in receiving of GPS (Global Positioning System) signals.

A further resonance occurs typically at a higher frequency in the range 1700-2000 MHz, e.g. 1870 MHz with a strong contribution from the coil portion 130 using the dimensions of the coil 101 given above. The antenna gain at this frequency is less than the maximum possible with an independent monopole antenna. However, for short-range wireless communication, at these high frequencies, the gain is acceptable. In any case, the antenna gain at this frequency can be improved by use section E finger 150, so that the Section A elongated by Section E of the antenna 100 together with coil portion 101 form a good monopole antenna at this frequency.

Advantageously, the inventors of the present invention have recognised that in producing the resonances described earlier, Section C is, and operates as, an inductive coil. In this regard, parasitic capacitance effects are not yet pronounced. However, the inventors have both recognised and utilised the fact that every coil behaves as an inductive coil only up to a particular maximum frequency. The inventors have observed this frequency to be approximately 1 GHz. At about 1 GHz, the inventors have found that the coil 101 begins to self-resonate and at higher frequencies the coil 101 alternates in behaviour between a capacitor and coil inductor. The effective lengths of Section A and Section E finger 150 are selected or tuned with very good wide band return loss (RL) and radiate particularly well in the Bluetooth (BT) frequency band of about 2.4 GHz to 2.5 GHz (2400 MHz to 2500 MHz) which is suitable for use in local area networks operating according to Bluetooth standards. In this case, the effective length of Section A and Section E together can be considered as a quarter-wavelength antenna (with the resonator isolated from, or orthogonal to, the rest of the antenna).

Changing the length of the section E finger 150 thus changes the length of the quarter-wave portion and its frequency. This is a high frequency, as the resonator is very short. When section E finger 150 is almost zero in length, the structure resonates at about 2.4 GHz. The resonant frequency decreases as the length of finger 150 increases.

Thus, a multifrequency antenna is produced using a fixed dual pitch coil, and additional tuning elements, including a conducting cylinder and high frequency finger at the base of the antenna, and a metallic capacitive insert near the top. An additional important feature of this structure is the control over the radiation pattern allowed by using these elements.

Antenna Design

Thus, as can be seen, the antenna configuration of the above described embodiment of the present invention provides the opportunity to provide a multi-mode operation to radiate in at least the following r.f. frequency bands:
(i) TETRA UHF (380 MHz-450 MHz) using substantially the whole effective length of the antenna 100;
(ii) Lower frequency GSM (850 MHz-960 MHz), known in the art as GSM ‘900’, using the Section B, i.e. coil portion 120 of the dual-pitch coil 101, together with the Section A;
   and preferably one or more of:
(iii) Higher frequency GSM (1700 MHz-2000 MHz), examples of which are known in the art as ‘DCS 1800’ and ‘PCS 1900’, using a pre-defined resonance frequency of the primary coil portion in Section ‘C’ 130 in interaction with other parts of the antenna; and
(iv) Alternative wireless frequency bands (operating say, at about 2-3 GHz, e.g. at 2.4 GHz) using section E, finger 150 together with the Section A.
(v) Additional resonances at intermediate frequencies, e.g. about 1250 MHz and 1580 MHz.

In accordance with an embodiment of the present invention, the inventors of the present invention have developed a new approach to tuning (controlling the resonant frequencies of) such an antenna. Referring now to FIG. 2, an approximate return loss performance 200 of the antenna 100 of FIG. 1 is shown. The return loss graph shows return loss 210 versus frequency 220. By way of explanation, a loss of signal known in the art as a ‘return loss’ or RL occurs in use in an antenna. RL is defined as the ratio of (i) the RF power returned by the antenna to the transmitter to (ii) the incident power from the transmitter. The more power returned the poorer is the tuning and the performance of the antenna. This loss can become greater as the frequency departs from an optimum operating frequency, which usually coincides with the centre frequency to which the antenna is tuned, or the centre frequency of the designated frequency band. In general, maintaining an acceptable RL over a reasonable band of frequencies is difficult.

Two resonant frequencies are shown in FIG. 2—F_{low} 230 and F_{high} 240. In free space, the following relationship was measured:
F_{high}/F_{low}=2.5 [1]

The desired ratio F_{high}/F_{low}, after application of the plastics case needs to be:
F_{GSM}/F_{c TETRA}=940 MHz/420 MHz=2.24 [2]

In the discussion which follows, the particular desired frequencies of 940 MHz and 420 MHz are referred to as the ‘main higher’ and ‘main lower’ frequencies.

Antenna Tuning

The key aspects relating to tuning such a multi-band antenna include:
(i) ensuring the correct ratio between the main lower and higher resonant frequencies as in [2] above; and
(ii) ensuring the correct placement of the centre frequencies of the respective operational frequency bands.

The inventors of the present invention have recognised that existing antenna tuning methods are not appropriate for the new multi-band antenna described above. In particular, the following standard options are not considered suitable:
(i) Changing the length of the short pitch portion of the coil, or replacing it with a straight base. Such a change would require new tooling to perform the injection moulding encasement for each new antenna.
(ii) Physically cutting the short pitch portion of the coil at the top (free end) of the antenna, to reduce the antenna length and thereby increase the resonant frequency. However, in the context of the present invention, the effect of such a cutting operation is that both the high and low resonant frequencies move down in frequency at proportionally the same rate.
(iii) Changing the ratio of the two pitches of the coil. Such a change affects the ratio between the main higher and main lower frequencies and (undesirably) a new tooling is required for each tuning trial.

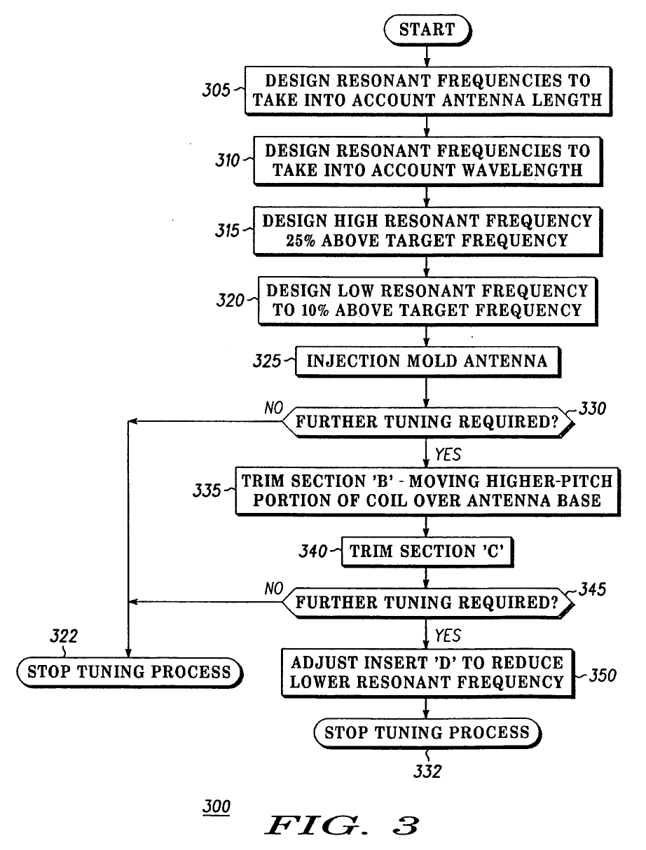

Therefore, in accordance with a further embodiment of the present invention, a new approach (involving additional elements) to antenna tuning is provided and is described with reference to the flowchart 300 of FIG. 3.

First, the two pitches, for the main lower and higher resonant frequencies, are designed to take into account any antenna length restriction, in step 305, and wavelength (λ), in step 310. Secondly, a high resonance frequency is designed for a frequency of approximately +25% above its target (main higher) frequency, as shown in step 315. A low resonance frequency is designed for a frequency of approximately +10% above its target (main lower) frequency, as shown in step 320, prior to injection moulding. Advantageously, if the ratio is selected correctly, given the adjustment that results automatically from the injection moulding process of step 325, no further tuning process is required.

However, if further tuning is required, in step 330, the length of the section B coil portion 120 is trimmed by moving the higher pitch section of the coil up and down over the base, as in step 335. It is proposed that this longer pitch section movement is used as a coarse adjustment of the antenna frequencies. A fine adjustment is achieved by trimming section C coil portion 130, as shown in step 340. The fine-tuning operation is particularly useful to accurately set the GSM higher frequency (at a frequency in the range 1700-1900 MHz).

During mass production, the properties of the injection moulded material can change a minor amount from batch to batch. For a standard one-frequency band antenna, this variation causes no problems, as the antenna coils may be trimmed (shortened) to compensate for the change in material permittivity. Such a technique is used, as no new tooling is required. However, the inventors of the present invention recognised that in the present antenna tuning operation, this trimming procedure mainly affects only the GSM frequency.

Therefore, if yet further tuning is still required, in step 345, the section D stub 140 may be adjusted in length to effect a change in the ratio between the main higher resonant frequency and the main lower resonant frequency. In particular, adjustment of Section D stub 140 reduces the main lower (TETRA) frequency, as shown in step 350. In this regard, it is now possible to fine-tune the dual-band (or higher-band) frequency antenna in production, after the injection process.

In the preferred embodiment of the present invention, insert ‘D’ 140 works in the following manner. Introduce a metallic insert near the top of the antenna. No tooling change is required for this tuning approach. However, the change primarily affects the lower Tetra frequency range that moves to a lower frequency, thereby changing the ratio between the two resonant frequencies.

Preferably, the insert is only lightly coupled to the coil, inasmuch as it should be arranged such that it only just reaches the last turn of the coil. In this context, the insert acts effectively as a capacitive load at the top of the antenna. Notably, at the GSM frequencies, the coil is by itself capacitive enough to be unaffected by the insert. Hence, the insert primarily affects the lower resonant frequency. This is especially useful, as no change to the production/injection tool is therefore required to tune the antenna for operation in multiple distinct frequency bands. Furthermore, production variations can be tuned out easily in this manner.

If no further tuning is required at any stage, the tuning process is stopped, as shown in step 332.

Notably, the antenna so produced preferably uses the whole antenna length, as any smaller antenna length will affect the peak gain performance of the antenna.

In summary, in the above manner, an antenna for TETRA operation is initially designed for operation without encasing at a frequency somewhat (about 10%) above the particular intended TETRA operating frequency band (430-435 MHz), with at least 6 db return loss at the lowest operating frequency of 410 MHz in free space. The antenna will, as described above, shift its centre frequency downward at normal operating conditions, by up to 20 MHz upon application of the injection moulding of the casing by injection moulding. The effect of designing the antenna to provide a slightly higher radiation frequency is to ensure that the antenna stays tuned under all operating conditions, following such a shift.

Measurements performed by the inventors of the antenna produced in the above manner for the above target main higher and lower target frequencies showed a 5-db return loss bandwidth over at least 50 MHz for the TETRA range. Beneficially, the antenna gain was comparable to a standard TETRA 400 MHz antenna made in a conventional manner, surprisingly with improvement at the band edges when connected to its transceiver of approximately 3 db.

Measurements performed by the inventors of the aforementioned antenna product showed a minimum return loss of 6 db return loss at the frequency band edges for the main higher frequency, lower GSM. As for the TETRA operation, the GSM antenna frequency was shifted downward by approximately 25% upon application of the injection moulded casing. The average antenna gain was measured as approximately 0 dbi. In particular, this GSM antenna could be tuned in situ (when attached to the GSM transceiver) to improve the matching, using a low pass tuning network. This tuning, for a dual-mode TETRA/GSM communication unit, also pulled the TETRA centre frequency down by approximately 5 MHz. Hence, this needs to be taken into account during the antenna design and manufacture.

Clearly, for an alternative dual-band antenna design that employs the inventive concepts hereinbefore described, it is within the contemplation of the invention that different frequency shifts will occur for different desired resonant frequencies.

A further important feature of the antenna embodying the invention is the improvement of antenna gain when the transceiver (and therefore the antenna) used in a portable unit such as a mobile phone is positioned near to a user's head, particularly for the lower GSM range of frequencies.

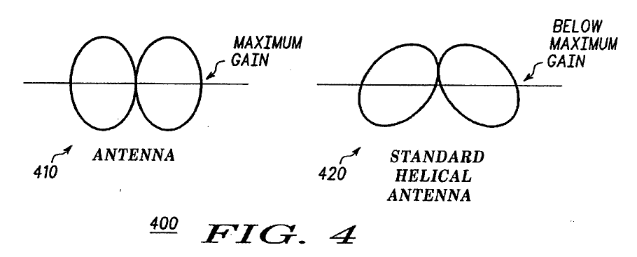

Referring now to FIG. 4, elevation-cut radiation patterns 400 for a known standard helical antenna 420 and the antenna 410 embodying the present invention are illustrated.

A standard helical antenna exhibits a radiation pattern 420 with an average vertical gain in the azimuth plane of about −15 dbi. The inventors of the present invention have measured the multi-frequency band antenna embodying the invention as exhibiting a radiation pattern 410 with an average gain of −9 dbi, noting that both the standard helical (GSM) antenna and the proposed dual-band (or higher) antenna have the same physical antenna length.

The improvement is brought about by two effects. First, the elevation radiation pattern for the new antenna is symmetrical, similar to an ideal dipole, whereas the standard conventional helical antenna has the radiation lobe diverted toward the radio enclosure and shows much larger angular zeros. When placed in the usual mobile user phone position the new multi-frequency band antenna shows main lobes which are still maximised at the horizontal plane, where they are measured. The standard conventional antenna maximum gain areas are therefore directed towards the ground and are therefore not utilized. An example of the elevation cut radiation patterns of the antennas are shown in FIG. 4. The second reason for the improvement, in reduced average gain, results from a little higher phase centre for the proposed antenna, in particular directed away from a user's head.

It will be understood that the aforementioned dual or higher band antenna design, for example a TETRA and dual GSM three band antenna, as described above provides at least the following advantages:
(i) provision of a small antenna;
(ii) a simpler and cheaper build, as only one radiator structure is required; consequently, it is suitable for encasement using a single injection moulding;
(iii) better radiation through beam forming in the GSM range; and
(iv) configurable to radiate at a number of (two or more) frequency bands at least one of which is well below 800 MHz, e.g. 380-450 MHz as well as at one or more frequencies above 800 MHz.

1. A multi-frequency band antenna for wireless communications, comprising a coil having a plurality of portions each having a different pitch including a first portion having a first pitch and a second portion having a second pitch, and an antenna base operably coupled to the coil for operable coupling to a multi-mode wireless transmitter, wherein the antenna is configured to radiate in use electromagnetic signals: in a first frequency band of said multi-frequency bands using the first and second portions of the coil; and in a second frequency band of said multi-frequency bands which is higher in frequency than the first frequency band using a length of said antenna base and substantially the first portion of the coil, wherein the first portion has a longer pitch than the second portion and the first portion has a first end attached to the antenna base and a second end attached to the second portion, and wherein the second portion has an effective electrical length substantially equivalent to a wavelength λ of radiation having a frequency corresponding to a frequency in the second band.

2. An antenna according to claim 1 and wherein the coil consists substantially of the first and second portions.

3. An antenna according to claim 1 or claim 2, wherein the first portion of the coil has an effective electrical length substantially equal to a quarter or less of the wavelength λ.

4. An antenna according to any one of the preceding claims, wherein said antenna base provides a contribution to effective electrical length of between an additional λ/10 and λ/4 for radiation in the second frequency band.

5. An antenna according to any one of the preceding claims and wherein the effective electrical length of the antenna is such that the first frequency band is in the range for TETRA operation of 380 MHz to 450 MHz.

6. An antenna according to any one of the preceding claims, and wherein the base and the first coil portion have an effective combined length such that the said second frequency is a frequency in the lower GSM frequency range of 850 MHz to 960 MHz.

7. An antenna according to any one of the preceding claims and wherein the base comprises at least one cylindrical portion coaxial with the coil and having a diameter not greater than that of the coil.

8. An antenna according to claim 6 and wherein the base includes first, second and third cylindrical portions, the second portion being between the first and third portion, the second portion having a diameter greater than that of the first and third portions.

9. An antenna according to any one of the preceding claims and further including a base elongation member operably coupled to the base to provide an additional contribution to radiation by the base.

10. An antenna according claim 9 and wherein the base elongation member comprises a conducting finger extending from the base axially inside the first coil portion.

11. An antenna according to claim 10 and wherein the finger has a diameter not greater than one quarter of the coil diameter of the first coil portion.

13. An antenna according to any one of the preceding claims and wherein the antenna configuration provides in use a resonance a contribution to which is provided by the second coil portion, the resonance being suitable for operation in the higher 1700-2000 MHz GSM range.

14. An antenna according to any one of the preceding claims, and wherein the antenna is configured to resonate at a frequency higher than the target first frequency to take into account a corresponding frequency shift reduction during application of a casing on the antenna.

15. An antenna according to any one of the preceding claims, and wherein the antenna is configured to resonate at a frequency higher than the target second frequency to take into account a corresponding frequency shift reduction during application of a casing on the antenna.

16. An antenna according to any one of the preceding claims, including a member coupled to the coil to effect a change in a frequency ratio between the first and second frequencies.

17. An antenna according to claim 16 and wherein the member coupled to the coil comprises a cylindrical stub co-axial with the coil to provide a capacitive loading on the coil.

18. An antenna according to any one preceding claim, wherein an elevation radiation pattern of the antenna is symmetrical thereby providing improved antenna gain in a direction substantially parallel to said antenna.

19. A method of tuning a multi-frequency band antenna according to any one of the preceding claims and including the step of:
varying a length of a long-pitch coil portion of the coil of said antenna by moving said long-pitch coil portion over said base of the antenna, thereby tuning a radiation frequency from said dual-pitch coil.

20. A method according to claim 19, the method further including the step of:
configuring a high resonance frequency provided by said high-pitch coil portion, and/or a low resonance frequency provided by said dual-pitch coil, at a frequency above a desired frequency (315, 320) such that an injection moulding process in manufacturing said antenna automatically tunes the antenna to said desired frequency.

21. A method according to claim 19 or claim 20, the method further including the step of:
moving an insert, connected to an end of said antenna to change a ratio between a higher resonant frequency and a lower resonant frequency.

22. A method of manufacturing an antenna according to any one of claims 1 to 18, the method including the steps of:
injecting a form over a dual-pitch antenna coil, to maintain the dual-pitch antenna coil in a fixed position, and
injecting an overmould substance to circumvent said dual-pitch antenna coil, thereby manufacturing a dual-pitch antenna.

23. A wireless communications unit including an antenna according to any one of claims 1 to 18.
